(19) United States
(12) Patent Application Publication
(10) Pub. No.: US 2011/0197237 A1
(43) Pub. Date: Aug. 11, 2011

(54) Controlled Delivery of Content Data Streams to Remote Users

(76) Inventor: Steven E. Turner, Selma, VA (US)

(21) Appl. No.: 13/123,372

(22) PCT Filed: Oct. 9, 2009
(86) PCT No.: PCT/US2009/060229

§ 371 Date: Apr. 8, 2011

Related U.S. Application Data
(60) Provisional application No. 61/104,577, filed on Oct. 10, 2008.

(51) Int. Cl. H04N 7/18

(52) U.S. Cl. 725/78

(57) ABSTRACT

The present system provides a website for distributing a plurality of content data streams converted into a common format, wherein each content data stream is encrypted and transmission of the content data stream is a function of available transmission rates to a given remote device.

### CROSS-REFERENCE TO RELATED APPLICATIONS

The present application claims the benefit of U.S. Provisional Patent application 61/104,577 filed Oct. 10, 2008.

### STATEMENT REGARDING FEDERALLY SPONSORED RESEARCH OR DEVELOPMENT

Not applicable.

### REFERENCE TO A “SEQUENCE LISTING”

Not applicable.

### BACKGROUND OF THE INVENTION

1. Field of the Invention

The present invention relates to a system for providing interactivity over a network, and more particularly to a system for providing a plurality of content data streams 30 in at least one of a common format and a digital wrapper or container format, wherein transmission rates and client capacity are monitored to maintain a continuous presentation of the content data stream, without requiring buffering.

2. Description of Related Art

There is considerable interest today in ways to integrate supplemental content information with broadcast media. For example, broadcasters seek ways to engage viewers by providing interactive content from a disparate content source, such as the Internet, that coincides with or supplements the program being broadcast. However, current interaction with the Internet is quite limited today, because the typical TV viewer does not have a personal computer conveniently located in the TV viewing room, nor is the typical TV viewer able to navigate to the appropriate Internet addresses while watching the TV program on the same display screen. In addition, current interaction approaches try to synchronize the supplemental Internet content with the broadcast program content cannot occur if the broadcast content is delayed such as through recording or time shifting.

Prior systems have employed Internet protocol television (IPTV) service as an alternative way to provide live TV programs to subscribers. In IPTV, TV programs may be transmitted on top of IP-based multicast. Similarly to traditional forms of broadcast television, for each TV channel, there is only one set of video stream content being broadcasted through the IPTV network. Also, similar to cable and satellite television delivery systems, the pricing for IPTV services is typically related to the number of channels and video quality, such as standard, digital or high definition TV programs.

The need exists for a method and system, which can provide a control over the delivery of content data streams 30, wherein the content data streams 30 include an integration of social media, live content and digital marketing. In addition, the need exists for a uniform presentation of content from a variety of different sources and formats, wherein multiple audio, video and data sources can be combined in a single player, without requiring additional downloads or software installation by the client. A further need exists for a method and system which can allow integration of a secondary content data stream with a primary content data stream in response to a predetermined synchronization, user initiated synchronization or data associated with the primary content stream.

### BRIEF SUMMARY OF THE INVENTION

In accordance with the present invention, there is a system including decoders, encoders and computers selected to configure content data streams 30 to a content delivery network, wherein the system provides a method of providing a plurality of content data streams 30 to a display screen at a remote location, by receiving a first data stream in a first format and a second data stream in a different second format; encoding the first content data stream and the second content data stream into a common format or at least wrapping one of the content data streams 30 in a predetermined file format; passing the encoded first content data stream and the second content data stream to a content delivery network; authenticating an instance of a player at the remote location, the authenticated instance communicating with the display screen; transmitting the first content data stream and the second content data stream at a transmission rate to the authenticated instance of the player; and adjusting a transmission rate of at least one of the first content data stream and the second content data stream in response to an available transmission rate between the content delivery network and the authenticated instance.

It is further contemplated the system can provide a method of displaying a content data stream, by displaying the content data stream in a first video canvas of an authorized instance of a player associated with a first display screen; selecting the first video canvas displaying the content data stream on the first display screen; initiating a display of the first video canvas on a second display screen associated with the authorized player; and terminating display of the first video canvas on the first display screen.

Also, the system can perform the method of providing a content data stream from a content delivery network to a first remote player and a second remote player, by authenticating the first remote player, the first remote player selected to generate a display on an associated first display screen; authenticating a second remote player, the second remote player selected to generate a display on an associated second display screen; determining at least one of a first available transmission rate and first transmission time between the authenticated first remote player and the content delivery network; determining at least one of a second available transmission rate and second transmission time between the authenticated second remote player and the content delivery network; and transmitting the content data stream to the authenticated first remote player and the authenticated second remote player, the transmitting corresponding to at least one of the first available transmission rate, the first transmission time, the second available transmission rate and the second transmission time, wherein the content data stream is displayed on the first display screen substantially simultaneous with the display of the content data stream on the second display screen.

The present system can additionally provide a method of displaying a content data stream, by authenticating a first remote instance of a player, the player associated with a first display screen for displaying the content data stream; displaying the content data stream in a video canvas on the first display screen; generating a second video canvas on the first display screen in response to one of a timing of the first data stream, a content of the first content data stream and metadata associated with the first content data stream; enabling a transaction through the second video canvas, independent of subsequent data in the content data stream; and closing the second video canvas upon completion of at least a portion of the transaction.

In the drawings and in the detailed description of the invention there are shown and described only principal embodiments of this invention and are of illustrative nature only, but not restrictive. Other embodiments and technical realizations are applicable, all without departing from the scope and spirit of the invention.

### BRIEF DESCRIPTION OF THE SEVERAL VIEWS OF THE DRAWING(S)

FIG. 1 is a schematic representation of the components of a configuration of the present system.

FIG. 2 is a schematic representation of an alternative configuration of the components in the present system.

FIG. 3 is a flow chart of user or client registration with the system.

FIG. 4 is a flow chart of user or client login to the system.

FIG. 5 is a flow chart of a process for operation of the video canvas within the player for presenting and viewing a content data stream.

FIG. 6 is a flow chart showing the monitoring of transmission and user metrics for controlling at least the quality of the content data stream.

FIG. 7 is a flow chart of a process for obfuscating content data stream names.

### DETAILED DESCRIPTION OF THE INVENTION

The following detailed description of certain embodiments presents various descriptions of specific embodiments of the present invention. However, the present invention can be embodied in a multitude of different ways as defined and covered by the claims. In this description, reference is made to the drawings wherein like parts are designated with like numerals throughout.

### DEFINITIONS

The following provides a number of useful possible definitions of terms used in describing certain embodiments of the present system and associated method.

A network may refer to a network or combination of networks spanning any geographical area, such as a local area network, wide area network, regional network, national network, and/or global network. The Internet is an example of a current global computer network. The network may be a hardwire network, wireless network, or a combination of hardwire and wireless networks. Hardwire networks may include, for example, fiber optic lines, cable lines, ISDN lines, copper lines, etc. Wireless networks may include, for example, cellular systems, personal communications service (PCS) systems, satellite communication systems, packet radio systems, and mobile broadband systems. A cellular system may use, for example, code division multiple access (CDMA), time division multiple access (TDMA), personal digital phone (PDC), Global System Mobile (GSM), or frequency division multiple access (FDMA), among others.

A website may refer to one or more interrelated web page files and other files and programs on one or more web servers. The files and programs are accessible over a network, such as the Internet, by sending a hypertext transfer protocol (HTTP) request specifying a uniform resource locator (URL) that identifies the location of one of the web page files, wherein the files and programs are typically owned, managed or authorized by a single entity or business. Such files and programs can include, for example, hypertext markup language (HTML) files, common gateway interface (CGI) files, and Java applications. The web page files preferably include a home page file that corresponds to a home page of the website. The home page can serve as a gateway or access point to the remaining files and programs contained within the website. In one embodiment, all of the files and programs are located under, and accessible within, the same network domain as the home page file. Alternatively, the files and programs can be located and accessible through several different network domains.

A web page or electronic page may comprise that which is presented by a standard web browser in response to an HTTP request specifying the URL by which the web page file is identified. A web page can include or link to a variety of content, for example, text, images, audio, video, and animation.

Content, content data, and media content may refer to electronic materials such as music, videos, software, books, multimedia presentations, images, text and other electronic data, which can be delivered as a stream or transferred, for example over a network to one or more users. Content data will typically be in the form of computer files for video, audio, text, program, data and other multimedia type content as well as actual physical copies of valuable content, for example CD-ROM, DVD, VCR, audio, TV or radio broadcast signals, streaming audio and video over networks, or other forms of conveying such information.

A computer or computing device may be any processor controlled device that permits access to the Internet, including terminal devices, such as personal computers, workstations, servers, clients, mini-computers, main-frame computers, laptop computers, a network of individual computers, mobile computers, palm-top computers, hand-held computers, set top boxes for a television, other types of web-enabled televisions, interactive kiosks, personal digital assistants, interactive or web-enabled wireless communications devices, mobile web browsers, or a combination thereof. The computers may further possess one or more input devices such as a keyboard, mouse, touch pad, joystick, pen-input-pad, and the like. The computers may also possess an output device, such as a display screen and an audio output or speakers.

These computers may be uni-processor or multi-processor machines. Additionally, the computers may include an addressable storage medium or computer accessible medium, such as random access memory (RAM), an electronically erasable programmable read-only memory (EEPROM), programmable read-only memory (PROM), erasable programmable read-only memory (EPROM), hard disks, floppy disks, laser disk players, digital video devices, compact disks, video tapes, audio tapes, magnetic recording tracks, electronic networks, and other techniques to transmit or store electronic content. In one embodiment, the computers are equipped with a network communication device such as a network interface card, a modem, or other network connection device suitable for connecting to the network. Furthermore, the computers execute an appropriate operating system such as Linux, Unix, any of the versions of Microsoft Windows, Apple MacOS, IBM OS/2 or other operating system. The appropriate operating system may include a communications protocol implementation that handles all incoming and outgoing message traffic passed over the Internet. In other embodiments, while the operating system may differ depending on the type of computer, the operating system will continue to provide the appropriate communications protocols to establish communication links with the network, such as the Internet.

The computers may contain program logic, or other representation of data and instructions, which cause the computer to operate in a specific and predefined manner. In one embodiment, the program logic may be implemented as one or more programs residing on or accessible by the computer.

The functionality provided for in the components, programs, and databases may be combined into fewer components, programs, or databases or further separated into additional components, programs, or databases. Additionally, the components, programs, and databases may be implemented to execute on one or more computers. In another embodiment, some of the components, programs, and databases may be implemented to execute on one or more computers external to the website. In this instance, the website includes program logic, which enables the website to communicate with the externally implemented components, programs, and databases to perform the functions as disclosed herein.

A content delivery network (CDN) 150 can be or include one or more suitable internet protocol based networks for transmitting content data such as multimedia content to servers or remote users. A CDN service provider typically maintains a number of computers in a network that can maintain content from various content providers. In turn, content providers can instruct, or otherwise suggest to, client computing devices to request some, or all, of the content provider's content from the computers of a particular CDN service provider. Preferably, the CDNs 150 are load balanced and fault tolerant at the client level.

Generally, the hardware assembly or software (broadcast nodes) are used to provide the encoded content data stream. The broadcast nodes provide inline transcoding of the content data stream from the IRDs. In one configuration, the broadcast node encodes one channel into Flash so as to retain the additional features/data such as surround sound. The requisite hardware assembly can be provided in a self-contained unit (SCU) which can include computers or servers, with appropriate inputs/outputs and with the presently described programs for implementing the disclosed functionality. Thus, an independent content provider can offer their content with the interactivity of the present system by employing an SCU. In one configuration, the independent provider can pass the content data from a camera, or post production, through the SCU, wherein the content is then distributed to the CDN or traditional content delivery system. It is further contemplated the content data passing through the SCU can be digitally wrapped as set forth below.

In conjunction, or as an alternative to the CDNs, broadcast nodes can be employed, wherein the broadcast node functions as a virtual CDN. The broadcast node includes the servers and associated software for transcoding content data streams 30 on the fly as more fully set forth herein.

Social media includes media designed to be disseminated through social interaction, created using highly accessible and scalable publishing techniques. Social networks employ internet and web based technologies to transform broadcast media monologues (one to many) into social media dialogues (many to many).

Social networks are understood to incorporate social media, which can take many different forms, including internet forums, weblogs, social blogs, wikis, podcasts, pictures, video, rating and bookmarking. Technologies include: blogs, picture-sharing, vlogs, wall-postings, email, instant messaging, music-sharing, crowdsourcing, as well as voice over IP. Many of these social media can be integrated via social network aggregation platforms including but not limited to Mybloglog and Plaxo.

Examples of social media communication software applications include, but are not limited to blogs such as Blogger, Livejournal, Open Diary, TypePad, WordPress, Vox, ExpressionEngine, Xanga; micro-blogging and presence applications including Twitter, Plurk, Tumblr, Jaiku, fmylife; social networking such as Bebo, Facebook, Linkedln, MySpace, Orkut, Skyrock, Hi5, Ning, Elgg and social network aggregation applications such as NutshellMail, FriendFeed.

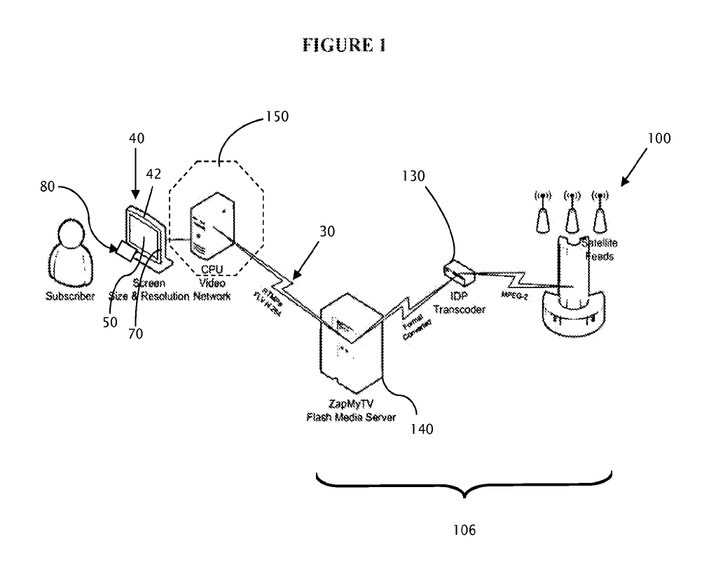

Referring to FIGS. 1, 2, and 3, the present system generally includes a website 10 accessible from a network 20, such as the internet, wherein the website provides content data streams 30 and interactive communication to remote computers 40 by virtue of a player 50 operating within a browser 70 on the remote computer 40. In one configuration, the remote computers 40 include a display screen 42 as well as an image capture device 80 connected to a computer commercially available webcam or video camera. However, it is understood the present system does not require an image capture device.

Generally, the system includes a satellite receiver or satellite receiver array 100; decoders 110, encoders 120, transcoders 130, and application servers 140.

In one configuration, at least some of the content data streams 30 are acquired from satellite transmissions, and thus the content data enters the system at the satellite receiver or satellite receiver array 100 and then passes to the decoders 110 such as an integrated receiver/decoder (IRD). The satellite or satellite array 100 is known in the art and receives content data from various content providers. Alternatively, or in addition the system can receive a channel stream at the head end 106 from a network, such as a virtual private network (VPN). Thus, such input would not pass through the present satellite and IRD.

The IRDs 110 are commercially available and generally used for the reception of contribution feeds intended for re-broadcasting through the CDN 150, or broadcast nodes. The IRD 110 is the interface between the receiving satellite receiver (or Telco networks) and the encoder 120. Digital broadcast streams received via satellite are decoded by the IRDs 110, wherein the output is passed to the encoders 120.

The encoders 120 are commercially available and employed to encode content data streams 30 to a predetermined format, such as compatible with a Flash Media Integrated Server (FMIS). A satisfactory encoder 120 encodes the content data streams 30 to a multimedia authoring program such as Flash or Quicktime as set forth below. Satisfactory encoding includes H.264 encoding supported by Adobe Flash Media Server 3.5 software. Encryption can be provided by Adobe Flash Media Rights Management Server implementation, such as RTMP or RTMPE. In one configuration, all individual content data streams 30 are encrypted. For example, the content data streams 30 can be delivered to an authenticated instance of the player via AES encrypted TCP connections to the CDN 150. The encoders 120 generate content data streams 30, which are sent to the FMIS head end server, which forwards the content data stream to the CDN 150 or broadcast node.

In one configuration, content data streams 30 are delivered via RTMP and RTMPE using the Adobe Flash Media Server software from a network hub to a last network node.

In one configuration, content data streams 30 from the encoders 120 are sent by a private network to the FMIS, wherein the content data streams 30 are then passed from the FMIS head to the CDN 150 by virtue of token authentication. It has been found satisfactory to perform the transcoding and aggregation on a redundantly secured private network to prevent breaches of content data during the transcoding process. Permanent storage of content data is also within a private network and is relayed to caching servers and the CDNs 150 as needed. The head end 106 can include redundancy to address potential hardware failure.

The encoded and encrypted content data stream 30 passes from the encoders at the head end for distribution to remote clients, as well as selective temporary archive, such as digital video recording.

As seen in FIG. 1, content data is received at the satellite array 100 and can be passed to the IDP in a first format, wherein the IPD transcodes the content data stream 30 to a predetermined format. The content data stream 30 then passes to the Flash Media Server where the content data stream is encrypted and passed to a server, processor, CPU or CDN 150, and then to the authenticated instance of the player 50 associated with the particular subscriber (user).

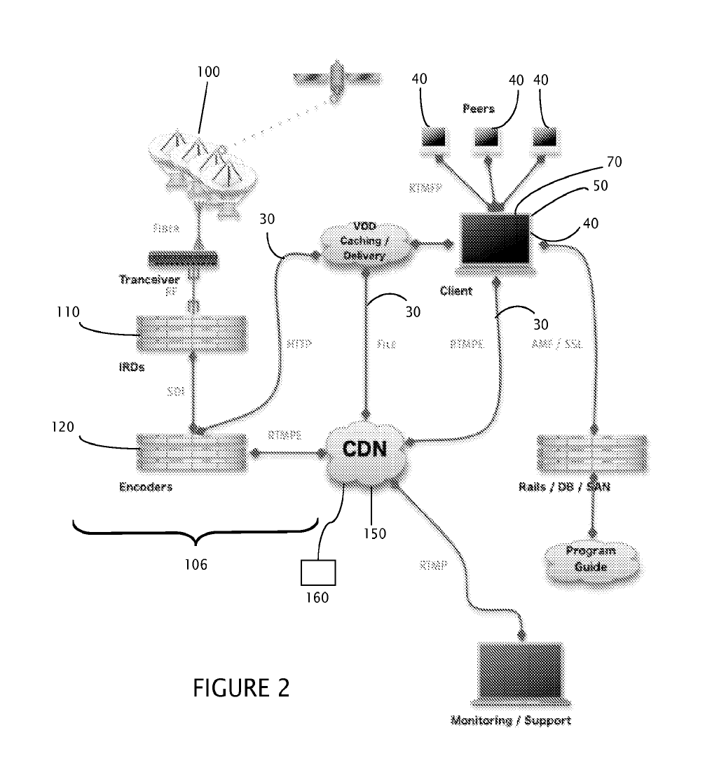

Referring specifically to FIG. 2, content data can be received at the satellite array 100, is passed through a transceiver, IRDs 110 and encoders 120. From the encoders 120, the content data streams 30 can be provided to the CDN 150 and/or a VOD system for caching and delivering a given content data stream 30 to a player 50 instance in response to an authenticated access request. In conjunction, program guide data can enter through the Rails system associated databases and storage area network (SAN).

Thus, a head end 106 can include servers, application servers, mass storage devices, as known in the art and in select configurations decoders 110 and encoders 120, IRDs and receivers. It is also contemplated the head end 106 can include or communicate with servers or storage of advertising content, which can be selectively provided to a particular instance of an authorized player.

From the CDN 150 or broadcast nodes, the content data streams 30 are selectively sent to remote clients for display by an instance of a player 50.

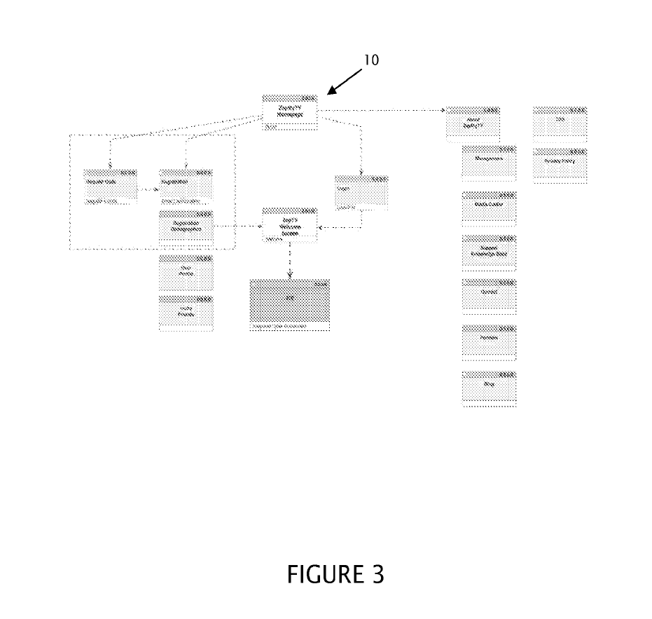

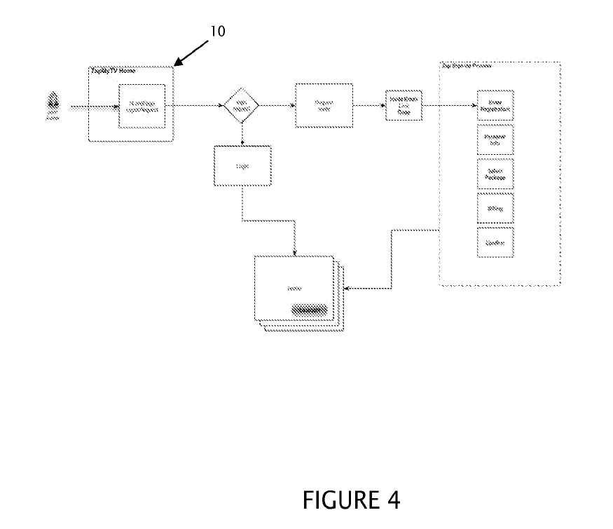

The player 50 is obtained by registering with the system which then provides for subsequent login, such as shown in FIGS. 3 and 4.

A user registers with the system by establishing an account, wherein the account can have a plurality of subaccounts. For example, the account could be created by the holder of a credit card, wherein the account owner establishes a primary account and at least one subaccount, and in select configurations a plurality of subaccounts. The account owner can determine the profile of each of the subaccounts. That is, the account owner can assign a level of content and security to each subaccount. The subaccount can be limited to certain times of access, filtering, purchasing as well as contacts. In one configuration, each subaccount could be classified as a predetermined age range, or the user age could be set and the system move the user through the age groups as the user ages. Exemplary age groups include 0-6, 7-13, 13-16, 16-18 and older than 18. It is contemplated that while the primary account may be searchable on a network, the subaccounts are protected so as to be invisible.

Further, if the subaccount seeks to “directly” communicate with a friend, such as through video, the account owner must contact the account owner associated with the friend, wherein contact information is exchanged in both directions. Thus, either account can accept or rejected the proffered communication. The acquired contact information is then provided to the system by each account owner as authorization for direct contact between the two subaccounts.

Generally, all connections and content data streams 30 are audited to maintain integrity and authorization. With respect to encryption, all content data streams 30 are delivered to the player 50 (client) via Advanced Encryption Standard (AES) TCP connections to the CDN, or the broadcast nodes. The client (remote computer 40) is tested for security best practices including decompiling resistance, stream capturing and known attack vectors to protect the content data streams 30.

Security and content data stream 30 quality can be done automatically as well as actively using commercially available programs. For example, connections and activity are monitored actively and automatically via commercially available firewalls and intrusion detection programs. In addition, client sampling can be employed to monitor and identify aberrant usage patterns.

Content data streams 30 and encoding are automatically restarted and configured in the event of content degradation. All instances of the player 50 at a client location, content data streams 30, CDNs 150 and data interactions provide monitoring and inspection points to maintain content integrity as well as provide forensic analysis of delivery of content data streams 30.

Thus, the stream manager of the authenticated player 50 requests a content data stream 30 from the CDN 150 or broadcast node. The requested content data stream 30 is then passed from the CDN 150 or broadcast node to the stream manager, which in turn passes the signal to the video switch. The content data stream 30 then passes to a video canvas in the player 50, and is thus viewable (or audible) on the associated display screen 42.

A metrics manager receives the metrics from the video canvas, and provides the metrics or data corresponding to the metrics to the broadcast node or CDN 150. The broadcast node or CDN 150 then adjusts or alters the content data stream 30 passing to the stream manager.

The player or video player 50 is a single player for providing a plurality of video, audio, and interactive functions, security and monitoring. As a single player is employed, the same codebase can be used for each of the video functions, security and monitoring. The video player 50 includes a video canvas, as well as provides for integration testing isolation and content data stream 30 integrity. The player 50 is automatically installed on the user computer 40 (or device) via an installer such as Flash Installer or AppStore for the iPhone upon login or authenticated access to the account.

Thus, the player 50 can decode the encrypted content data stream 30 in accordance with the commercially available configuration. As set forth below, in the Adobe suite the decryption keys are a component of Flash player Actionscript Virtual Machine (AVM) and are selected so to not to be revealed in any currently known small web format (SWF) decompiling process.

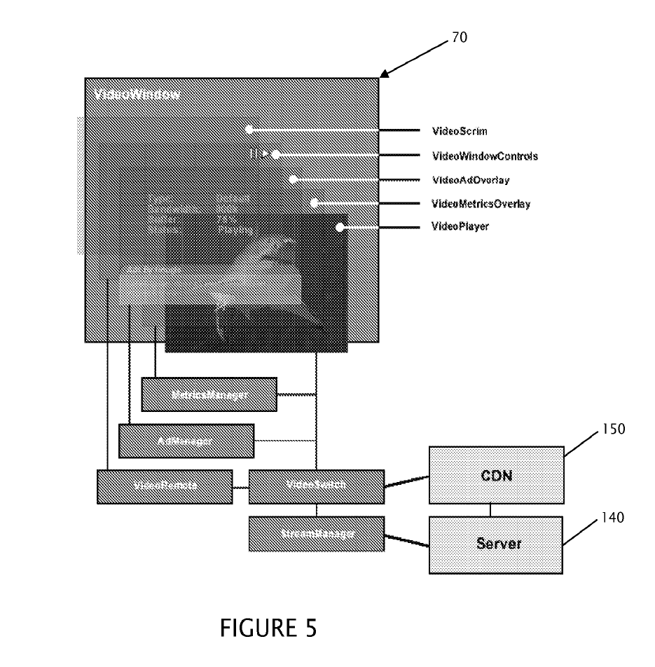

As seen in FIG. 5, the video player 50 includes a Videowindow; VideoScrim, Videowindows controls, videoadoverlay, videometorcsoverlay and Videoplayer.

The VideoWindow is integrated into the user interface of the remote computer (client) using the VideoWindow class:

```
<media:VideoWindow
    Id=”mywindow”
    Width=”800”
    Height=”450”
    VideoAlign=”center”
    playerType=”vod”
    showMetrics=”true”
    showControls=”false”
    windowControls=”VideoWindowsControls_instance”
    streamToken=”zapTestStream1”
    clientToken=”zapTestClient”/>
```

This tag creates an instance of the VIdeoWindows, which creates in Metricsmanager, AdManager, StreamManager and VideoSwitch instances. This set of instances constitute a unique streamPath, of which there can be any number in the client at any given time, such as video or picture-in-picture (PIP).

The properties of this class are videoAlign—if the width and height do not correspond to the video aspect ratio or is scaled smaller than its normal size, the video can be aligned left, center or right; playerType—employs default live and video on demand (VOD) streams in the main window. Using the playerType “preview” optimizes the player for preview viewing, such as roll over in a schedule grid. The playerType “chat” configures the player for video chat. To view any PIP stream, playerType “preview” should be used, as well as for viewing outgoing chat stream; showMetrics makes the player diagnostics overlay visible; showControls shows or hides the inline player controls; windowControls pass an instance of a class that extends VideoWindowControls to provide customized inline video controls; streamToken is a reference to a stream to play, wherein no stream names are passed to the client player until after authorization of the client and the content data stream request; clientToken is a unique session reference passed to the client on startup, which is used for authorization in the Stream Manager; autoPlay specifies if the content data stream 30 will play automatically once the content data stream is available.

An additional class allows embedding of a “remote control” anywhere in the user interface. Methods can be called which control the transport for a particular instance (e.g., play, pause, resume and seek) and events are fired from the stream path (e.g., netStream events, metrics and ad events).

<media:VideoPlayerRemote
streamPath=”{mywindow.streamPath}/>”

The properties of this class include streamPath which specifies the unique stream path (e.g., a unique id for a particular live content data stream 30, chat session or VOD) to control by remote.

Several dynamic elements are controlled by the metadata associated with the content data stream 30, such as a video, including scrimOverlay, as a large icon or scrim, that covers the entire VideoWindow during a video stop state; static image—provides an image displayed beneath the scrim, if any, but over (above) all other VideoWindow components during a stop state; and adOverlay which is triggered during netStream ad events.

The video player 50 further monitors the volume of the content data streams 30 at the client computer 40 and allocates available resources including transmission rates and processing capacity. That is, each instance of the player and hence video canvas is interdependent and the utilization requirements of each player instance is a function of the remaining instances of the video canvas.

The player 50 also permits the client to initiate PIP viewing of multiple content data streams 30, each within a corresponding video canvas. In one configuration, the audio associated with the PIP is muted until the client selects the PIP as the main video canvas. It is also contemplated the audio associated with a particular video canvas can be automatically enabled and disabled in response to the position of the cursor on the screen. As the system monitors the location of a cursor or other input device and the location of the video canvas(es), the system can employ the position of the cursor to cause an associated audio data to be audible, without requiring any clicking by the user. Thus, by moving the cursor to overlay a given video canvas, the player 50 can automatically initiate a sufficient volume, while terminating the audio of the vacated video canvas. The number of available video canvases is constrained only by bandwidth (transmission rate) to the client computer 40.

Thus, the video canvas is distinct from windows of prior commercially available graphical user interfaces. The present video canvases are under the control of a single player, wherein the content data stream 30 of one video canvas is dependent upon the content data stream presenting at a second video canvas. Thus, the display of a content data stream in one video canvas is adaptive to the display of a second content data stream in a second video canvas on the same display screen. In addition, the video canvas can present content data streams 30 of different formats including different encoding formats.

The player 50 is constructed in a multimedia authoring program for viewing animations and movies using common commercially available computer programs such as a web browser. Available web browsers include Windows Internet Explorer, Mozilla Firefox, Apple Safari, Google Chrome, and Opera. Thus, the player 50 runs within the browser on the client computer, as a browser window.

A satisfactory multimedia authoring program Adobe Flash Player, or Flash. The Flash Player is a widely distributed proprietary multimedia and application player created by Macromedia and currently developed and distributed by Adobe. Flash Player runs Small Web Format or Shockwave (SWF) files that can be created by the Adobe Flash authoring tool, by Adobe Flex or by a number of other Macromedia and third party tools.

Adobe Flash, or simply Flash, often refers to both the multimedia authoring program and the Adobe Flash Player, written and distributed by Adobe, that uses vector and raster graphics, a native scripting language called ActionScript and bidirectional streaming of video and audio. Adobe Flash is the authoring environment and Flash Player is the virtual machine used to run the Flash files, it is understood that in industry literature the term “Flash” can mean either the authoring environment, the Player, or the application files.

The Flash Player is available as a plug-in for recent versions of numerous web browsers (such as Mozilla Firefox, Opera, Safari and Internet Explorer) on selected platforms. In addition, Flash is compatible with a number of mobile operating systems.

In one configuration, from an edge node of the CDN 150 to the client (subscriber) computer 40, the content data streams 30 are delivered directly to the software client using Adobe Flash Media Server.

A further multimedia authoring program for the player 50 is QuickTime developed by Apple Inc. Quicktime is capable of handling various formats of digital video, media clips, sound, text, animation, music, and interactive panoramic images. QuickTime Streaming Server has been found satisfactory for stream in the QuickTime format, wherein stream segmenting and implementation of AES 128 encryption for.

The player 50 is configured to deliver the content data stream to the display screen connected to the authenticated client device, such as a computer or pda.

As the user input passes through the website 10, all user interactions can be monitored and recorded, such as by keystroke or key logging, as well as screen logging. Thus, each action of the user with respect to the website and hence associated content data can be measured. For example, initiation and abandonment (or termination) of viewing content data; pausing and resuming view.

This monitoring can be used to provide a dynamic or active filtering. As specific sites are restricted by individual users, the system monitors such restrictions of the associated website and can automatically add the website to a different class or restricted group. As the geolocation allows the system to know the location of each client, the system can tailor the classification of websites as a function of other users as well as geographic location. For example, what is not restricted in New York City, may be restricted in Saudi Arabia.

The dynamic filtering can be uniquely applied to different subaccounts of a given user. It is contemplated the account may have a plurality of subaccounts, wherein each of the subaccounts is associated with a specific age user or age range. The system can then restrict certain websites for selected ages and hence subaccounts, thereby allowing different subaccounts to view different content data streams 30 or websites 10.

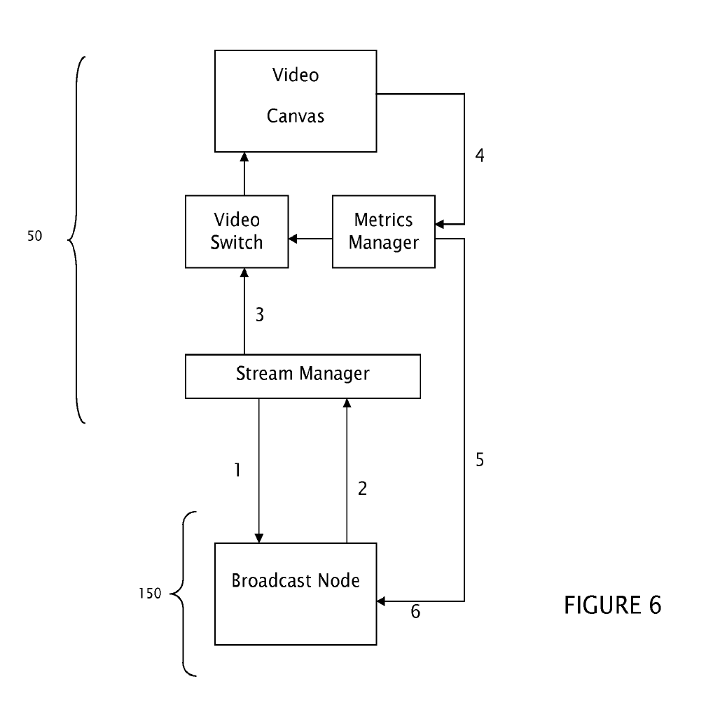

Referring to FIG. 6, quality of service (or available transmission rate) is actively monitored by real time metrics from each client computer or device 40. Content data streams 30 are rerouted and additional streaming servers are deployed in response to demand according to network conditions. The content data streams 30 can be rerouted topologically to the nearest access as well as across CDNs 150 to avoid network congestion. That is, the CDN 150 and/or broadcast nodes are continuously load balanced.

It is also contemplated that user created content can be shared through the system. For such content, the user uploads the user created content, which is passed through the encoders 120 and thus labeled and disseminated as other content data streams 30. However, it is contemplated that at least some user created content data may be encoded by the authenticated instance of the player 50, and the content data stream 30 then passes from the originating instance of the player to the CDN 150, and then to the system storage for archival. In certain instances of the player 50, the content data stream 30 to be encoded is passed through the built in codec, such as the Sorenson codec. However, depending on load balancing, it is understood that if excess demands were placed on the instance of the player 50, the content data stream 30 could be passed to a broadcast node or the encoders at the head end 106. That is, as the system is actively monitoring loads, transmission rates and user activity, the system can react to changing demands.

In select configurations, the system passes all content data streams 30 though the encoders 120, thus depending on the demand for a PIP feed from a client (user), the content data stream 30 is passed through the encoder and then is passed to the terminal end. The user generated PIP can thus be provided to a viewing circle in either a private or public viewing. Further, passage through the encoder allows separate encryption of the content data stream 30 that is the PIP.

With respect to social networking, micro-blogging service and short message service (SMS), these inputs remain in the native format, but are wrapped in a digital container or wrapper and can thus be tracked as with the associated video canvas.

That is, some of the content data streams 30 are digitally wrapped in the player 50. That is, in those configurations employing Adobe Flash, selected content data streams 30, such as the text of twitter or Facebook, are maintained in the originating format and Flash is used to provide the special file format metadata for the storage and transport of the wrapped content stream. Adobe Flash is thus used to provide the file format (or stream format) which specifies the way the wrapped content data stream is stored, but not coded, within the file and the available metadata. In these configurations, the Adobe Flash wraps the content data stream by storing the actual content data stream and the information about how the content data stream is stored within the file. Thus, the instance of the player 50 can treat the wrapped content data stream 30 as a Flash encoded content data stream.

By disposing content data streams (whether streaming or merely a document) through the encoders 120 (and thus creating a common content independent format), the system allows a user to select a content data stream 30, whether third party or self generated and whether video, audio or text, to be shared to predetermined “affinity” group, criteria meeting third parties, all third parties, or restricted invitation.

With respect to self-produced, or client created content data, such content data streams 30 are passed through the encoders and are thus treated as incoming third party commercial content data streams 30—thereby having associated metadata, transmission control, encryption and authentication.

Further, as such client created content data streams 30 can be monitored by the system, viewing can be tracked and relatively new client content data stream can be associated with an existing commercial entity allowing for sponsorship, advertising or product placement opportunities for both parties.

The present system further provides for the obfuscation of content data stream names on the CDN 150 and the ability to store and retrieve metrics on the content data streams 30.

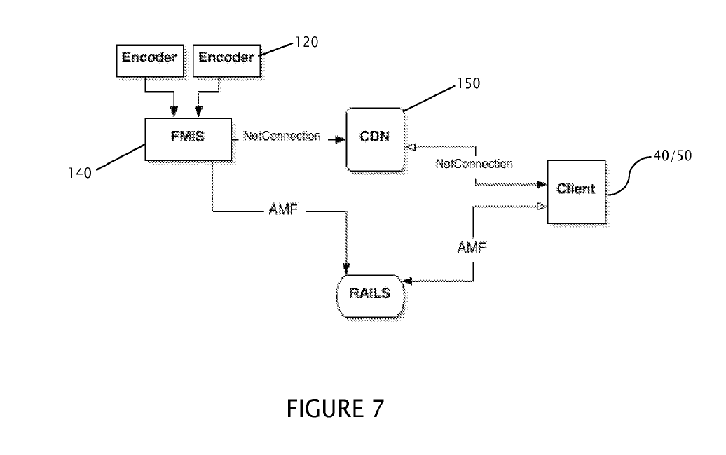

Referring to FIG. 7, the obfuscation of content data stream names on the CDN 150 is accomplished by a token authorization model involving an open source web application framework for the Ruby programming language, such as Ruby on Rails (Rails), on a back end and a software development for the deployment of cross-platform rich internet applications based on the Adobe Flash platform, such as Adobe Flex, Adobe AIR and ColdFusion. Specifically, when the content data streams 30 originate from the encoders 120, the streams are broadcast to the Flash Media Integrated Server (FMIS), which in turn publishes the content data stream 30 to the CDN 150. As the content data stream 30 is published to the CDN 150, the FMIS communicates to the Rails back end the name and the location of the stream. The Rails back end stores the stream name and generates a random string, such as a universally unique identifier (UUID) which is used as a public stream name. The Rails back end also associates the content data stream with program guide data, such as by using the content data stream location and a current time to associate a stream with a channel. As set forth in the description of the variable bit stream component, there can be multiple streams associated with each program item, that is multiple bandwidths and recorded DVR streams. Once the Rails back end has returned a new name for the content data stream, the FMIS server then publishes the stream to the CDN.

Authorization of the client computer 40 and instance of the player 50 is provided by passing a program guide key, or token, to the player. The player 50 then passes to the Rails back end, this token along with a token unique to the client (user), wherein the unique client token may be a string to be delivered to the client from a user management module. Upon completion of this passing, the Rails back end will send the video player 50 a list of streams associated with the requested program.

It is contemplated the token can be a number used once (nonce), wherein the nonce can be a random or pseudo-random number issued in the authentication protocol to ensure that old communications cannot be reused in replay attacks. For instance, the nonces are different each time that authentication challenge response code is presented, and each client request from the authenticated instance of the player has a unique sequence number, thus making replay attacks and dictionary attacks exceptionally difficult.

Thus, content data stream requests must be validated using a one time token sent and audited separately prior to start of transmission of the content data stream. Clients (computers 40) are precluded from connecting to a content data stream 30 unless a one-time token sent and audited separately is provided.

Content data stream inventory is provided by a reference stored in the Rails back end. All content data streams 30 generated in the technology stack (such as, but not limited to encoders, origin, video chat) will have a reference, even if the content data stream is not publically available.

Metrics associated with the content data stream 30 are stored as XML for a predetermined period of time, such as between approximately 12 to 24 hours. For each content data stream 30, a set of non-specific individual identifying metrics is stored for the predetermined time. That is, the stored metrics are not identifying the specific user, but rather representative of demographics of the user such as a statistic characterizing human populations (or segments of human populations broken down by age or sex or income etc.) Each metrics datum is time stamped so that the metrics can be reconstructed using a Flex client. The communication between the Flex client and the Rails back end is provided in action message format (AMF).

For example, the data used as a stub for retrieval of a content data stream location, is provided by a request by the user for a particular program data item.

```
<location name=“rickRoll” type=“vod”>
    <connection>
        <application>vod</application>
        <ip>192.168.1.1</ip>
    </connection>
    <stream>
        <name>Never Gonna Give You Up</name>
        <type>vod</type>
        <uid>anIHk77#ks\hat{ }kssaap</uid>
        <url>astley_never_gonna_1200k</url>
        <videobitrate>1200</videobitrate>
        <audiobitrate>96</audiobitrate>  <events>
            <event>
    <type>com.zapmytv.events.ClosedCaptioningEvent</type>
            </event>
            <event>
                <type>com.zapmytv.events.AdEvent</type>
            </event>
        </events>
    </stream>
    <stream>
        <name>Never Gonna Give You Up</name>
        <type>vod</type>
        <uid>dioNmsomKk6KkM00akw</uid>
        <url>astley_never_gonna_800k</url>
        <videobitrate>800</videobitrate>
        <audiobitrate>96</audiobitrate>  <events>
            <event>
    <type>com.zapmytv.events.ClosedCaptioningEvent</type>
            </event>
            <event>
                <type>com.zapmytv.events.AdEvent</type>
            </event>
        </events>
    </stream>
    <stream>
        <name>Never Gonna Give You Up</name>
        <type>vod</type>
        <uid>oosmaii833kMMlw92&m</uid>
        <url>astley_never_gonna_400k</url>
        <videobitrate>400</videobitrate>
        <audiobitrate>48</audiobitrate>
        <events>
    <type>com.zapmytv.events.ClosedCaptioningEvent</type>
            </event>
            <event>
                <type>com.zapmytv.events.AdEvent</type>
                </event>
            </events>
    </stream>
</location>
```

When metrics data is received, the metrics data will have an arbitrary structure due to heterogeneous stream types (VOD, SVOD, video, chat, data). An illustrative example is:

```
<metrics streamType=“vod”>
    <uid>ggYx5rrd</uid>
    <metric>
        <name>ave_buffer_pct</name>
        <value>67</value>
    </metric>
    <metric>
        <name>num_insifficient_bw</name>
        <value>0</value>
    </metric>
</metrics>
```

Generally, a single IP network connection is supported per player 50 instance at the client location. In cooperation with the geolocation information, the client (subscriber) can be selectively prevented from receiving selected content data streams 30 as a function of the internet access point. The player 50 is configured to be renewed, wherein security renewal does not require permission of the client. Renewal is initiated by setting an invalidity flag in the player 50. The invalidity flag causes the player 50 to automatically renew by loading the appropriate version from the website. However, the player 50 can be revoked by rendering the player non-functional. In one configuration, the player 50 loads from a secure location with a one time use token. Upon initialization, the token is returned to the security server to authorize the player to connect to the website 10, or network.

Upon connection to the website 10, network or specific server, the player 50 must pass the token for each content data stream 30 along with a one time use token acquired from the security server prior to receiving each content data stream. The receipt of each single use token is predicated on validation of user credentials and user content permissions (as can be set by the account administrator).

The variable bit stream technology provides that the content data stream 30 is encoded in one of a plurality of predetermined transmission rates. For example, the encoders 120 provide the content data stream 30 at any one of 400K, 800K, 1.0M and 1.2M. As there is an active link between the CDN 150 and the client or user computer 40 by virtue of the instance of the player 50 running on the client computer 40, the available transmission rate is continuously (at least perceived as continuously) monitored. Thus, if the encoder 120 is providing the content data stream 30 at 800k and the available transmission rate drops to 700k, the variable bit stream program adjusts the transmitted content data stream to the available transmission rate, by transcoding the encoder provided 800k content data stream 30 to the available 700k transmission rate. The variable bit stream program continues to transcode the content data stream 30 between the available predetermined rates from the encoder 120 as a function of the available transmission rate to the respective client. Upon the available transmission rate matching one of the predetermined encoder 120 rates, the variable bit stream technology requests the nearer predetermined rate from the encoder and passes such rate to the client (authenticated instance of the player 50).

As applied to a broadcast node, the variable bit stream program allows the software to bridge the gaps between the available transmission rates for the content data stream 30 as provided by the encoders 120.

In one configuration, the FMIS provides dynamic streaming to automatically detect and switch among different bit rates, allowing remote clients to view content data streams 30 without pauses or interruptions. Further, in one embodiment all content data streams 30 are monitored by the system to detect and isolate faults. Further, the parameters and events are captured by the system from clients to broadcast flag streams.

Encryption can include industry standard real time messaging protocol encryption (RTMPE), wherein the RTMP can be encapsulated within HTTP requests to traverse firewalls or RTMPS which operates over a secure HTTPS connection. Further, for Adobe FMS, SWF verification can be employed in addition to RTMPE.

In addition, the system contemplates the use of one (single) use tokens, wherein upon authentication with the system, a first single use token is passed to the authenticated instance of the player 50. When the user requests a content data stream 30, the first single use token is passed from the player 50 to the server 140, and a second single use token is passed to the player with the content data stream 30, at which time the token is no longer valid. When the player 50 (user) requests a second content data stream 30, the second single use token is passed to the server 140 and a third single use token is passed to the player 50 with the second requested content data stream 30. Each time a token is passed, the system authenticates the request against a plurality of factors such as billing or accounting, subscription level, applicable filters, including content filters, viewing circles, events and blackouts (geographic restrictions). Currently, the exchange of single use tokens and authentications requires approximately 3 seconds or less.

Since a token is only valid the associated content data stream, if the token is twice presented to the server 104, the system recognizes the attempt and can implement any of a variety of responses such as deactivation or invitation to resend.

The use of the single use tokens can also be applied to other devices registered within a given account. For example, if the user has registered an iPhone 160 with the system, an authenticated instance of the player can be initiated on the iPhone. Then, from the iPhone a request can be made from the iPhone and the associated single use token and content data stream are transmitted to the iPhone. Authentication including authentication with the service provider of the iPhone can occur with each token exchange, again checking system parameters as well as parameters with the iPhone service provider.

As the iPhone 160 has GPS capability, and the system actively tracks each connection, the system can monitor the location of the iPhone relative to the geographic location of the computer of the account holder (which is known as set forth below). Thus, if the system detects the iPhone 160 having travelled greater than a predetermined separation from the geographic location of the computer of the account holder, the system can terminate communication with one of the devices, typically the stationary device.

Further, the system can be configured such that upon initiating viewing of a content data stream 30 on the iPhone 160, the transmission to the stationary instance of the player is terminated within a predetermined time.

In addition, as the iPhone 160 is a registered device with the system, the iPhone can run a remote control application to function as a remote control of the authenticated instance of the player 50, or the iPhone can function as a camera (video camera) providing content data stream 30 to the authenticated instance of the player 50. It is also understood the run programming to provide cursor control (function as a mouse or input device) on a secondary separate authenticated device or computer. That is, the commands, such as cursor control or keyboard input, generated by the iPhone 160 are transmitted to the secondary device, and as the system (authenticated players 50), monitor the location of the displayed content data 30 on the respective display screen 42, the commands from the iPhone 160 can control and modify the display on the remote display screen of a separate authenticated instance of the player 50.

The content data stream 30 can be provided to the iPhone 160 by HTTP streaming.

Geolocation allows a given viewer (user) to be limited to specific network or geographic area, such as by ZIP codes, or alternatively stated access can be denied based on the same parameters. Geolocation is the process of automatically identifying a physical location of a client without the user having to provide any information, such as a ZIP code. Geolocation is available for virtually all web browsers and does not require any plug-ins or cookies. Generally, geolocation employs a mapping of internet protocol addresses to a specific location. Additional data used in geolocation includes cell tower usage and Wi-Fi access points. Satisfactory geolocation data is provided by Quova Inc. Thus, the IP address known by the system can be used to provide information such as country, region, city, postal/zip code, latitude, longitude and time zone for the given IP address, and hence user.

Thus, the present system either acquires or accesses a database providing the location, wherein location can include country, region, city, postal/zip code, latitude, longitude or time zone of a given user and can implement necessary blackouts of content data stream 30 restrictions related to geographic location.

This geographic data is stored in or accessed by the system and is used with advertising, such as adOverlays, and compliance with content data stream 30 licenses.

Initiation of the adOverlay (VideoAdoverlay) can be set to any of a number of triggers. For example, the adOverlay can be initiated at predetermined intervals along a content data stream 30. Alternatively, the adOverlay can be initiated at predetermined times, independent of the timing of any content data stream 30 in a video canvas. It is further understood the adOverlay can be initiated in response to metadata associated with the given content data stream 30. That is, in received content data streams 30 at the IRD 110, the content data stream may include metadata such as title, director, actors, summary of the contents, length of the recording, critical rating, and the data and source of this recording, as well as file name and current status (viewing status, ‘save until’ date. Thus, the adOverlay can be initiated in response to a particular type or content of metadata.

Further, the content of the adOverlay can similarly be provided corresponding to the subject matter of the metadata. Thus, content data streams 30 of romantic comedies will initiate different adOverlays than playoff football games. It is further contemplated that the system, typically at the encoding step can associate additional metadata with the content stream, thereby providing for more specific tailoring of the adOverlay timing and content. For example, a product placement can be noted at a particular time in the content data stream, such that the adOverlay for the product or a related product appears simultaneous or substantially simultaneously with product placement in the content data stream 30.

Additionally, the system monitors the input from the user through the website 10. Specifically, keystroke logging, and mouse position and input are monitored. Therefore, the system can associate particular websites visited and actions taken. This information can be stored for the particular user (client) as well as at a common geographic or demographic interest. This accumulated usage data can also be used to time and associate adOverlays with a given content data stream. Therefore, the initiation and content data stream for an adOverlay can be a function of the geographic location of the user, the profile of the user, the metadata associated with the prior content data stream as well as the viewing history of the user.

The content data stream 30 to be provided in the initiated adOverlay is stored in system servers or storage accessible by the system servers (or CDN). The content data stream for the adOverlay can provide a real time transaction through the internet, allow the client to save or print a coupon or advertisement or link to a particular third party website.

As an example of the real time transaction, the initiated adOverlay can provide for a complete transaction without interrupting the prior, and now simultaneously displayed, primary content data stream 30. If the adOverlay is for a local pizza provider, the adOverlay allows communication to the internet so that the client can size the adOverlay as desired, select an offered food, order the food and receive confirmation and close the adOverlay, without requiring the user to change any aspect of the viewing of the primary, or triggering, content data stream. It is understood, the system monitors the content data streams 30 to the client player and the available transmissions and maintains the continuous display of the respective content data streams 30 at the respective display screen associated with the player 50.

It is also contemplated the present system can provide program guide data (as seen in FIG. 2) for identifying content data streams 30 (such as television shows) for viewing. The guide data can be obtained from a third party provider, such as Macrovision, wherein the guide data is displayed in a video canvas in the traditional grip format. From monitoring data of the client, and the subscriber population, the system can automatically identify items that are most popular (overall and within a genre), viewer ratings, show viewed by friends or a viewing circle, advanced searching (actor, director, time, broadcaster, etc) as well as suggested items (based on viewing habits and friend connections). Metadata from content data providers can also be included in the displayed grid. In one configuration, video on demand would also be listed by title, genre, and provider.

In addition, as the system monitors cursor location and location of each content data stream 30 on the respective display screen (and the location of data within the stream), upon display of the guide data, the system can be configured so that a user can select a given term in the guide data and a search is automatically initiated on the selected data. The particular search engine and location(s) for searching can be predetermined by the user or the account owner. For example, if the guide data has an entry of a movie and lists the main actors, the user can select the name of the main actor, and the system will automatically conduct a search using the user defined search engine to locate additional information about the actor.

Thus, the present system provides a platform for providing live streaming content data streams 30, such as cable or satellite television broadcasts across a network, such as the Internet to any streaming device, wherein the streaming content data can be integrated with social media, such as twitter or Facebook. The present system provides the viewing circles to integrate streaming content data streams 30 such as television with online social media and social networks, where in the streaming content data streams 30 are commonly experienced in real time at remotely located instances of the player 50. Thus, the present system provides for access to and viewing of licensed live cable television, social networking, interactive video, video on demand (VOD), subscription video on demand (SVOD), user generated content including video, text and audio chat in a single website by virtue of a player instance within the browser of the user computer.

In the viewing circles, multiple viewers can share a synchronized or non-synchronized content data stream, and invite others to join—subject to individual subscriptions (authorization) to a particular content data stream. It is contemplated the viewers within a viewing circle can share remote functionality of the presently described DVR controls with a predictive synchronization the maintains timing across multiple clients. As the system will control the transmission rate of the delivery of each content data stream 30 to each member of the viewing circle, substantially simultaneous delivery of the content data stream can be achieved by transmitting at the slowest transmission rate within the viewing circle. In addition, since each member of the viewing circle is an authenticated account (or subaccount) and the transmissions to the members are synchronized, the remote control of the content data stream can be transferred to any member of the viewing circle.

The present system allows viewers to view live streaming content data streams 30, wherein the variable bit stream provides for consistent live presentation of the content data stream, as the actual available transmission rate (as a function of bandwidth and network traffic) dictates the actual transmission rate of the content data stream to the respective player instances.

In view of the provided encryption, access to the content data stream 30 is generally prevented to any other device or program. Other than the short term buffer, as set forth above three seconds or less, is stored at the remote computer at any time. In addition, as each content data stream is authorized on a per account/per device basis access to the content data stream is controlled. In one configuration, access to each content data stream is linked to a single token or nonce, authorized for the unique access. Multiple access is checked and rejected prior to any access attempt during the content data stream look up process.

The encryption and authentication of the instance of the player 50 is selected to substantially inhibit, with the objective of precluding, recording of a content data stream 30. Thus, no material amount of the content data stream 30 is cached, other than buffered transient data, to provide for broadcast flag compliance.

The present system also provides for digital video recording of the content data streams 30, independent of whether the content data stream was actually viewed by the client as a live content data stream.

The present system can record each of the available content data streams 30 within the universe of available content streams.

In one configuration, the system receives, aggregates and encodes television programming from a wide variety of “content providers”—the various broadcast and cable channels that produce or provide individual programs—and selective transmits the encoded content data stream to the remote location of the player instance of the individual client. The system receives the content data stream of a third party content provider, encodes and transmits the content data stream to the requesting client in real time. Thus, if a Cartoon Network program is scheduled to air Monday night at 8 pm, Cartoon Network transmits that program's data to the system and other cable companies nationwide at that time, the system immediately re-transmit the data to customers who subscribe to or select that channel in the present website.

The system can include or subscribe to a Remote Storage DVR System (RS-DVR). The RS-DVR allows system clients to record or view recorded content data streams 30 on central hard drives of the system at a “remote” location. Thus, the system can automatically capture each content data stream 30 at the RS-DVR for a given period of time (such as 1 day, 3 days, 7 days, 14 days 21 days or any period as permitted by the system configuration and content licenses), wherein the client can selectively view any of the stored content data streams 30 during the given period of time. During the given period of time RS-DVR users may then receive playback of those content data streams 30 through the present website to the authenticated player instance.

Under the RS-DVR, an encoded content data stream 30 is split into two streams. The first content data stream is routed immediately to client. The second content data stream is transmitted to a number of high-capacity hard disks. In selected configurations, the storage can be at the head end 106 or with the CDNs 150, wherein the stored content can be retained in an on-demand cache. Further, the content data streams 30 can be stored in arbitrary segments from approximately 1 minute to 30 minutes in length and reassembled in response to demand to transmitted to the client player instance.

To the client using the website 10, the client can select any recorded content data stream 30, which is then transmitted to the client computer 40. No actual content is stored on the client computer 40, and the client does not initiate the recording. The client merely bookmarks or searches and accesses already stored, cached, content data at the head end 106 or the CDN 150. Depending on the agreement with the content provider, pause, rewind and fast forward of the content data stream 30 can be selectively applied. It has been found satisfactory to limit the amount of cached content data stream at the client computer to approximately 180 second or less.

The present system can provide VOD, SVOD in a manner paralleling the treatment of other content data streams 30. That is, content data is stored in encrypted form and transcoded on the fly for multiple bandwidth streams (available transmission rates). It is contemplated that selected content data may be transmitted on a rental or purchase basis via Adobe AIR and Adobe Flash Digital Rights Management Services.

The website 10 is effectively a video portal for live television broadcasts, social networking, PIP video, audio or text chat, interactive advertising. By providing the content data streams 30 through head end and hence website, the present system allows for a user to view the available content from any internet access point. As each video canvas is content independent, each video canvas can be manipulated in previously unavailable manners.

For example, the client can use a personal digital assistant, handheld or palmtop computer to control the player instance website. Thus, the control panel can be displayed on any selected (and authorized) display screen of the client, thereby allowing the client to experience the interactivity from anywhere (subject to blackout controls from the stored geolocation information).

As the video canvas is independent of the display screen on which it appears, a video canvas can be passed from a desktop or stationary display screen to a personal digital assistant, handheld or palmtop computer. In application, the system monitors both keystrokes and cursor position on the client display screen 42. In addition, the system monitors which video canvas, window, is selected or primary. As provided in the setup or establishment of an account, specific devices are authorized with, and thus recognized by the system. Therefore, during display of a content data stream 30 on a first display screen 42, the player 50 can provide a user identifiable transfer location on the first display screen, wherein the player constructs the user identifiable transfer location to represent instruction to transfer transmission of the video canvas from the first display screen to a second, previously authorized, display screen associated with the account. Thus, the user by selecting a given video canvas on the first display screen and associating the selected video canvas with the user identifiable transfer location can cause the selected video canvas (with the associated content data stream) to cease transmission to the first display screen and initiate transmission to the second display screen. Thus, as each content data stream 30 is through a corresponding video canvas, the respective video canvas can be passed to a second display screen of the client, without interrupting the transmission.

The transmission rate monitoring of the present system can be employed in conjunction with a virtual theater. In the virtual theater, a client (subscriber) can invite specific individuals to simultaneously view at a plurality of remote locations a common content data stream, such as a movie. In one configuration, the invitees navigate through respective instances of the player to an online “ticket agent” and initiate viewing at a common time. During the viewing of the common content data stream, the invitees can interact through a separate video canvas by text, audio or video or any combination. The system continually, as perceived by each invitee, monitors the available transmission speed to each invitee and transmits the selected content data stream at the slowest common rate, such that all relevant players simultaneously display the content data stream. That is, the previously described variable bit stream program applies to the transmission of the content data stream to the invitees.

The active filtering of the present system can be applied to any of a variety of content data streams 30. In one configuration, the present system can employ a web crawler for available online radio stations, and present a list of such available stations to the client, wherein the active filtering is applied to the list so that the client, or subaccounts of the client can access only selected stations from the list. It is also contemplated the system can employ web crawlers to monitor newly created websites and apply a rating to such newly created websites, and thus provide filtering for the content.

The present systems further provides a synchronization between content data streams 30 not previously attainable. By encoding each content data stream, monitoring transmission rates and employing metadata, the present system can synchronize content data streams 30, independent of whether the content data stream is live or time shifted. Thus, the player as authenticated upon access, and subsequent requests for access to content data streams 30 provides for viewing live streaming television broadcasts, wherein a plurality of content data streams 30 can be synchronized (such as by shifting to a particular transmission rate, by metadata, by available transmission rates), and the content of social networks can be integrated within the player.

Thus, as provided above requests for access to a content data stream 30 are queried (authorized) against a geolocation authorization database for each content data stream and timeblock within a content data stream, wherein requests or existing streams outside of an authorized geographic area for either the authorized instance of the player 50 or the client (account owner) are blocked or disconnected. It has been found satisfactory to query or authenticate with respect to geolocation in response to a request for access to a content data stream and at periodic intervals during transmission of the content data stream. The periodic interval can be predetermined intervals such as 5 minutes, 15 minutes, 30 minutes or hour based intervals. It is also understood the predetermined intervals can be on the order of a minute or less. With respect to the iPhone geolocation data can be obtained from commercially available iPhone location services.

Further, an instance of the player 50 is identified uniquely only while participating in a session using account credentials and the described temporary nonce tokens. Clone devices are inhibited by the required download of verified software (the player) upon access in combination with the account credentials upon access. Simultaneous connections (hence simultaneous access to content data streams 30) are disallowed at access to the content data stream and authorization. As each access is subject to both device (computer 40) and software authorization, previously authorized devices can be prevented from access. Thus, a device 40 or instance of the player 50 is treated as non-trusted and is validated or authenticated upon each request for access to a content data stream. Updates for the player 50 are pushed to the client device or provided upon download (installation) of the player from the server, such as a head end 106 server 140, upon access.

The present system also provides for interactivity by use of a reverse “green” screen. The image capture device 80 associated with an authenticated account can be used to map an unoccupied room. That is, the camera 80 captures the image, the data is transmitted to the server (or accomplished at the player level) and the pixel representation of the room is mapped. The user then enters the room and the image capture device captures the user and again captures the room. However, the server 140 or (player 50) removes the previously mapped background, thereby providing a digital representation of the user. The system can locate or dispose the digital representation of the user against any desired background layer, such as a gaming environment or learning environment. The system can thus register user movements without requiring manipulation of an input device by the user.

In one configuration, the system has the following specification:

| | |
|---|---|
| Stream Content | |
| Codec | AVC H.264 |
| Resolution | SD 720 × 480 |
| Container | RTMPE/HTTP (iPhone) |
| Encryption | AES (Adobe RTMPE Implementation) |
| Authentication | Client token (two levels) |
| Authorization | Both request and delivery |
| DVR | |
| Encryption | AES (Adobe RTMPE Implementation) |
| Storage | Head end and CDN |
| Caching | CDN (up to 7 days - as determined by |
| | licensed content) |
| Downloadable content | |
| Encryption | AES (Adobe FMRMS Implementation) |
| Codec | AVC H.264 |
| Resolution | SD 720 × 480 |
| Container | mp4/flv |
| DRM | Flash Media Rights Management Server with |
| | Adobe AIR application |
| Delivery | |
| CDN | LimeLight/Influxis or custom |
| Storage | Head end |
| Caching | Head end and CDN (On demand) |
| Clients | |
| Supported OS | WindowsXP - Vista - Apple OS 10.4+ |
| Flash | Flash Player 10 |
| iPhone | iPhone OS 3 |
| Server Specifications | |
| OS | Red Hat Enterprise 5 |
| App Servers | Rails, ColdFusion 8, J2EE |
| Databases | postgreSQL 8 |
| Firewalls and Intrusion | |
| Detection | |
| Firewalls | Juniper Networks, IP firewall |
| Intrusion Detection | Snort] |
| Encoding and | |
| Transcoding | |
| Hardware | Digital Rapids |
| Software | Digital Rapids Stream, FFMPEG, Transcode |
| | and Flash Media Server |

In one configuration, the presently described system employs Adobe Flash 10 and can operate on commercially available PC computers running Windows XP, Vista or 7 as well as Mac brand computers running OS X 10.5 or higher; and for the iPhone running 3G, 3GS and ipod touch OS 3.1.

For the PC and Mac computers, a satisfactory codec/bit rate and resolution has been found to be H.264-AAC 1384k-720P or H.264-AAC 1184k-720P or H.264-MP3 528k-360×240. For the iPhone satisfactory codec/bit rate and resolution has been found to be H.264-AAC 364k-360×240. Encryption can be via Adobe Flash 10 with Adobe RTMPE ecryption (AES) and for the iPhone AES128 bit using 16 octet keys.

The encryption keys are managed by the delivery platforms: for the PC Adobe RTMPE/FMIS/Flash Access 2.0; the Mac Apple HTTP Live Streaming/QuickTime streaming server and for the iPhone OS 3.1.

Further, the system is configured so that asset management includes structured metadata with each live content data stream VOD/Electronic Sell Through (EST) asset. In response to each request for access, the metadata determines how the asset (content data stream) will be used. All metadata management and storage is done within a private network, such as a VPD, such that the user does not have access to any metadata.

Upon receipt, the authenticated player decrypts the content data stream with the Flash AVM (and in the iPhone the content data stream is decrypted with the QuickTime library.

The secrets (such as keys, keys derivatives) are managed by the respective platform (Adobe Flash or QuickTime), wherein authorization is managed using the temporary nonce, which are discarded once used.

While a preferred embodiment of the invention has been shown and described with particularity, it will be appreciated that various changes and modifications may suggest themselves to one having ordinary skill in the art upon being apprised of the present invention. It is intended to encompass all such changes and modifications as fall within the scope and spirit of the appended claims.

1. A method for providing a plurality of content data streams to a plurality of viewers, the method comprising:
identifying a viewing circle comprising a plurality of viewers;
instantiating a player on a plurality of computers, each computer associated with one of the viewers, the player comprising an executable program on each computer that provides a video canvas on a display screen associated with each computer for viewing the plurality of content data streams;
transmitting the content data streams simultaneously to each instance of the player on each computer; and
synchronizing transmission of the content data streams to all player instances to provide simultaneous delivery in real time of the content data streams to each viewer in the viewing circle by adjusting a transmission rate of the content data streams to a slowest available transmission rate within the viewing circle.

2. The method of claim 1, wherein the content data streams comprise live streaming content data streams integrated with social media.

3. The method of claim 1, wherein the content data streams comprise at least one of live cable television, social networking, interactive video, video on demand, user generated content, user generated video, text chat and video chat.

4. The method of claim 1, wherein the method further comprises receiving a user generated content data stream from an instance of the player associated with one of the viewers; and
adding the user generated content data stream to the contact data streams transmitted to each instance of the player on each computer.

5. A method for displaying a plurality of content data streams, the method comprising:
instantiating a first player on a computer associated with one viewer in a circle of viewers, the player comprising an executable program on the computer that provides a plurality of simultaneous video canvases on a first display screen associated with the computer for viewing the plurality of content data streams, each video canvas facilitating display of at least one content data stream in the plurality of content data streams;
transmitting the content data streams simultaneously to each viewer in the circle of viewers at a transmission rate that is a slowest available transmission rate within the viewing circle;
initiating viewing of the content data streams on the plurality of video canvases of the instance of the player associated with the display screen;
using the player to monitor a volume of content in the content data streams and to allocate the transmission rate of the content data streams to the computer and a processing capacity of the computer among the plurality of video canvases based on the monitored volume of content in the content data streams.

6. The method of claim 5, wherein the method further comprises:
instantiating a second player and an associated video canvas on a second display screen associated with of the viewer; and
passing at least one content data stream from the transmitted content data streams to the second player on the computing device for display within the associated video canvas on the second display screen; and
adjusting allocation of the transmission rate of the content data streams between the first player and the second player based on the content data stream passed to the second player.

7-14. (canceled)

15. The method of claim 1, wherein the method further comprises:
providing remote control over transmission of the content data streams to the viewers in the circle of viewers; and
transferring remote control of the content data streams to any viewer in the circle of viewers.

16. The method of claim 1, wherein the method further comprises:
monitoring available transmission rates within the viewing circle continuously; and
adjusting the transmission rate of the content data streams in response to a change in the slowest available transmission rate in the viewing circle.

17. The method of claim 1, wherein the method further comprises recording the content data streams on central hard drives by splitting the content data streams to create a first stream containing the content data streams transmitted directly to the viewers in the viewing circle and a second stream containing the content data streams transmitted to the central hard drives for storage.

18. The method of claim 1, wherein the method further comprises:
receiving content from a plurality of content providers;
aggregating the received content; and
encoding the aggregated received content to create the content data steams; and
wherein the step of transmitting the content data streams further comprises transmitting the content data streams comprising the encoded aggregated received content in real time.

19. The method of claim 1, wherein the method further comprises:
instantiating a second instance of the player on a second display screen associated with one of the viewers, the second display screen associated with a computing device separate from the computer associated with that viewer; and
passing the transmitted content data streams to the computing device for display on the second display screen without interruption in synchronized simultaneous transmission of the content data stream to all viewers in the viewing circle.

20. The method of claim 19, wherein the method further comprises adjusting the transmission rate of the content data streams in accordance with an available transmission rate to the computing device to which the transmitted content data streams are passed.

21. The method of claim 6, wherein passing the content data stream to the second player and adjusting allocation of the transmission rate occurs without interruption in the simultaneous transmission of the content data stream to all viewers in the viewing circle.

22. The method of claim 5, wherein the method further comprises using the player to:
move one of the video canvases associated with the first player and content data streams being viewed with that video canvas to the second display screen; and
adjust the allocation of the transmission rate and processing capacity based on the movement of the video canvas to the second display screen.

23. The method of claim 22, wherein movement of one of the video canvases to the second display screen is in response to viewer initiated movement of that video canvas on the first display screen.

24. The method of claim 22, wherein the second display screen is associated with a computing device separate from the computer associated with the one viewer from the circle of viewers.

25. The method of claim 5, wherein the method further comprises:
monitoring a location of a viewer controlled cursor displayed on the display screen and location of each one of the plurality of simultaneous video canvases displayed on the display screen; and
enabling audio associated with each video canvas in response to a location of the displayed cursor in relation to each video canvas.

26. The method of claim 5, wherein:
the method further comprises constructing the player in a multimedia authoring program for viewing animations and movies; and
the content data streams comprise live streaming content data streams integrated with social media.

27. A method for displaying a plurality of content data streams, the method comprising:
instantiating a player on a plurality of computers, each computer associated with one viewer in a circle of viewers, the player comprising an executable program on each computer that provides a video canvas on a display screen associated with each computer for viewing the plurality of content data streams;
using an image capture device associated with one of the plurality of computers to map a pixel representation of an unoccupied room containing that computer;
using the image capture device to map a pixel representation of the room occupied with a given viewer associated with that computer;
removing the pixel representation of the unoccupied room from the pixel representation of the room occupied with the viewer to create a digital representation of the given viewer;
adding the digital representation of the given viewer to the content data streams;
transmitting the content data streams to the other viewers; and
displaying the digital representation of the given viewer on at least one additional video canvas associated with one of the other viewers in the circle of viewers.

28. The method of claim 27, wherein:
the content data streams are transmitted simultaneously to each viewer in the circle of viewers; and
the method further comprises synchronizing transmission of the content data streams to all player instances to provide simultaneous delivery in real time of the content data streams to each viewer in the viewing circle by adjusting a transmission rate of the content data streams to a slowest available transmission rate within the viewing circle.
